(19) United States
(12) Patent Application Publication
(10) Pub. No.: US 2013/0194366 A1
(43) Pub. Date: Aug. 1, 2013

(54) SYSTEMS AND METHODS FOR DIGITAL RAISED PRINTING

(71) Applicants: Michelle N. Chrétien, Mississauga (CA); Christopher Wagner, Toronto (CA); Naveen Chopra, Oakville (CA); Peter G. Odell, Mississauga (CA); Barkev Keoshkerian, Thornhill (CA); Jennifer L. Belelie, Oakville (CA)

(72) Inventors: Michelle N. Chrétien, Mississauga (CA); Christopher Wagner, Toronto (CA); Naveen Chopra, Oakville (CA); Peter G. Odell, Mississauga (CA); Barkev Keoshkerian, Thornhill (CA); Jennifer L. Belelie, Oakville (CA)

(73) Assignee: Xerox Corporation, Norwalk, CT (US)

(21) Appl. No.: 13/359,218

(22) Filed: Jan. 26, 2012

(51) Int. Cl. B41J 2/01

(52) U.S. Cl. 347/102

(57) ABSTRACT

Systems and methods are provided for digital printing of Braille or other raised printing. In some embodiments, ink is printed directly from a print head onto a substrate, rather than onto a transfer drum that is later printed onto a substrate. In some embodiments, a plurality of layers of a curable, phase-change ink are printed onto the substrate, wherein pauses of a predetermined time are included in between of layers to enable the curable, phase-change ink to set up into a given shape and height. In some embodiments, temperatures of printing components are lowered from those used for traditional printing, so as to enable the curable phase change ink to set up into a given shape and height. In some embodiments, spacing of components are altered from those used for traditional printing, so as to enable the curable phase change ink to set up into a given shape and height.

### BACKGROUND

The embodiments provided herein relate to systems and methods for digital raised printing and more specifically to digital raised printing by printing curable phase change ink directly onto a substrate.

Typically, two main technologies are available for printing Braille and other raised printing: 1) embossing and 2) thermal paper expansion. Neither is easily adapted to producing digital prints. As used herein “digital printing” refers to variable data printing, wherein different images can be printed using the same unmodified apparatus, such as, for example, inkjet printing (as opposed to, for example, flexography, offset printing, and gravure printing). A simple solution for digital generation of Braille and other raised printing is therefore desirable, particularly for governments and large institutions which are required by law to provide Braille prints for visually impaired people. Furthermore, commercial packaging converters are increasingly being asked/mandated (see e.g., Canada and EU) to provide Braille printing on packages for the pharmaceutical industry.

Accordingly, robust digital printing of producing Braille and raised text would be advantageous in that it would enable personalization, accessibility to home users, ease of combination with regular text, the ability to easily generate Braille representations of mathematical and chemical equations and financial formula, and/or provide other advantages.

### SUMMARY

According to embodiments illustrated herein, novel systems and methods for digital raised printing are provided. In some embodiments, a method is provided for digital raised printing, the method comprising placing a substrate onto a substrate engaging surface; sequentially applying a plurality of layers of a curable phase-change ink from a print head onto the substrate, wherein a predetermined period of time elapses between the application of each layer; and curing the plurality of layers of ink on the substrate.

In some embodiments, a system is provided for digital raised printing, the system comprising a substrate engaging surface that receives and holds a substrate on which ink is to be applied; a print head that sequentially applies a plurality of layers of a curable phase-change ink onto the substrate, wherein a predetermined period of time elapses between the application of each layer; and a curing portion that cures the plurality of layers of ink on the substrate.

In some embodiments, a system is provided for digital raised printing, the system comprising a print drum that receives and a substrate on which ink is to be applied; a substrate holding portion that holds the substrate to the print drum; a print head that sequentially applies a plurality of layers of a gel-based curable phase-change ink onto the substrate, wherein a jetting temperature of the print head is between 55° C. and 65° C. during application of each of the plurality of layers, wherein the print drum is maintained at a temperature of between 10° C. and 20° C. during application of each of the plurality of layers, and wherein a predetermined period of time elapses between the application of each layer; and a curing portion that emits ultraviolet light onto the substrate to cure the plurality of layers of ink on the substrate.

### BRIEF DESCRIPTION OF THE DRAWINGS

For a better understanding of the present embodiments, reference may be had to the accompanying figures.

FIG. 1A illustrates a side view of an example of a system for use according to various embodiments;

FIG. 1B illustrates a top plan view of an example of a system for use according to various embodiments;

FIG. 2 illustrates an example of a process for use according to various embodiments;

FIG. 3A illustrates optical profilometry results for an embossed Braille dot;

FIG. 3B illustrates optical profilometry results for a digitally raised Braille dot produced according various embodiments.

### DETAILED DESCRIPTION

In the following description, it is understood that other embodiments may be utilized and structural and operational changes may be made without departure from the scope of the present embodiments disclosed herein.

In some embodiments, systems and methods for digital printing of Braille or raised text are provided herein. In some embodiments, the systems and methods print directly from a print head onto a substrate, rather than printing ink onto a transfer drum that is later printed onto a substrate. In some embodiments, a plurality of layers of a curable, phase-change ink may be printed onto the substrate, wherein pauses of a predetermined time are included in between of layers to enable the curable, phase-change ink to set up into a given shape and height. In some embodiments, temperatures of printing components are lowered from those used for traditional printing, so as to enable the curable phase change ink to set up into a given shape and height. In some embodiments, spacing of components are altered from those used for traditional printing, so as to enable the curable phase change ink to set up into a given shape and height.

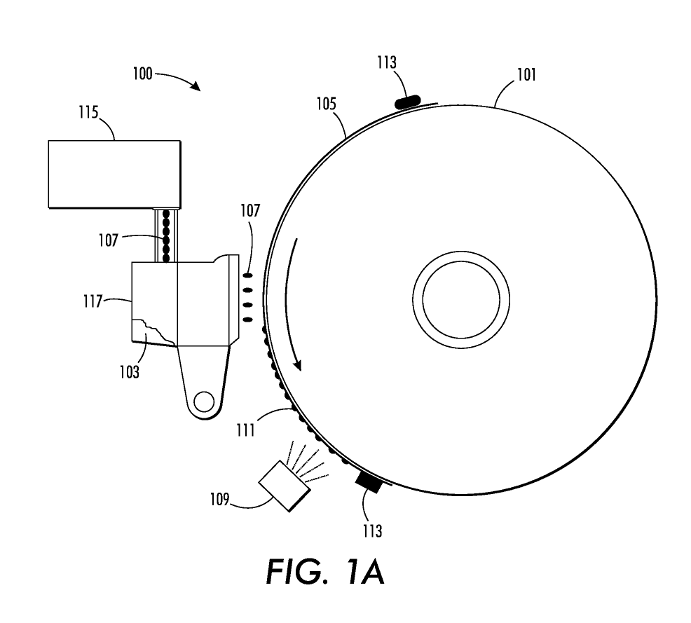

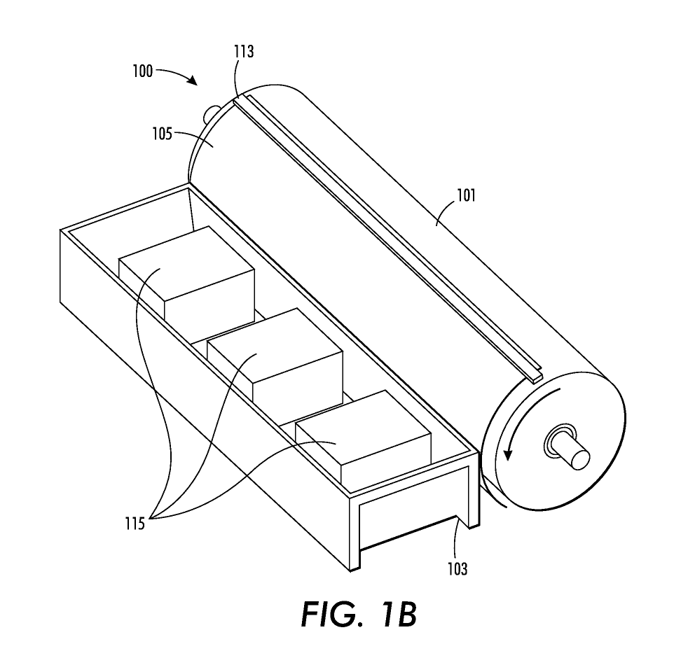

FIGS. 1A and 1B illustrate a system 100, which is an example of a system for digital printing of Braille and/or raised text. System 100 may include a substrate engaging surface 101, a print head 103, a substrate 105, ink 107, a curing portion 109, and/or other elements.

In some embodiments, substrate engaging surface 101 may be or include a print/transfer drum (e.g., an anodized aluminum or Viton™ drum) or other object that provides a surface onto which substrate 105 may be received and held in place. In some embodiments, substrate 105 may be held in place on substrate engaging surface using one or more bars 113. A bar 113 may be a “hold down” or “gripper” bar that has a tacky and/or non-slip (e.g., rubber) surface that holds substrate 105 in place on substrate engaging surface 101. In some embodiments, other elements may be used to hold substrate 105 to substrate engaging surface 101 such as, for example, electrostatic forces, suction, tape, adhesive, or other elements.

In some embodiments, print head 103 may be or include an inkjet print head or other print head capable of receiving ink 107 and sequentially applying a plurality of layers of ink 107 onto substrate 105. In some embodiments, print head 103 may include a reservoir 117 and may be supplied with ink 107 by an ink loader 115. In some embodiments, print head 103 may be or include a piezoelectric print head that utilizes one or more piezoelectric elements to propel ink from an reservoir 117 onto substrate 105.

In some embodiments, substrate 105 may be or include paper (coated or uncoated papers), cloth, plastic, polymer (e.g., uncoated Mylar™ polymide, polyether sulfone [PES], biaxially oriented polypropylene [BOPP]), cardboard or card stock, DuraPaper™, metal foil, or other substrate that is receptive to ink 107 and that can be affixed to substrate engaging portion 101.

In some embodiments, ink 107 may be or include a curable phase-change ink such as, for example, a gel-based ultraviolet (UV) light-curable phase-change ink. In some embodiments, inks described in the following published U.S. patent application may be used: U.S. Patent Application Publication No. 20100053287 (filed Sep. 4, 2008, entitled: “Ultra-Violet Curable Gellant Inks For Braille, Raised Print, And Regular Print Applications”), the contents of which is hereby incorporated by reference herein in its entirety. The nature of a gel-based ink at room temperature prevents spread or migration of printed droplets and allows for facile formation of the Braille or raised print markings.

In some embodiments, curing portion 109 may include an ultraviolet (UV) light source (e.g., light bar) that projects UV light onto layers of ink 111 that have been applied to substrate 105 so as to cure the ink into a solid phase. Other curing methods may be used. In some embodiments, curing portion 109 may be incorporated into a printing apparatus that uses the system components described herein such that curing layers of ink 111 takes place in an “on-line” fashion. In some embodiments, curing portion 109 may be separate from the printing components of such an apparatus or otherwise separate from the apparatus so that curing takes place in an “off-line” fashion.

In some embodiments, the temperature of one or both of print head 103 or substrate engaging surface 101 may be altered from those used with conventional printing. For example, print head 103, which may typically be kept at a jetting temperature of between 85-95° C. for conventional printing, may be lowered to a range of about 55-65° (e.g., so that ink 107 exits print head 103 at a range of about 55-65° C.). In some embodiments, print head 103 may be kept at about 60° C. (e.g., so that ink 107 exits print head 103 at 60° C.). Other temperatures may be used, including temperatures lower than 55° C., depending on the ink used. This may be done so that the curable phase-change ink is not too hot exiting print head 103 so that it is able to form the specified shape (for Braille, a circular dot) and height. If ink 107 is too hot coming out of print head 103, it may be too flat and/or oddly shaped when applied onto substrate 105. A cooler print head 103 (and therefore cooler ink 107) sets up into a more consistent three-dimensional shape, thus enabling raised printing for the specified shape. However, some inks may be able to set up at higher temperatures. Accordingly, in some embodiments, the jetting temperature may vary from between about 55-95° C., depending on the ink used.

Similarly, substrate engaging surface 101 (e.g., transfer drum/print drum), which may be kept at a temperature of between about 22-25° C. for conventional printing, may be kept at a temperature of between about 10-20° for raised printing. In some embodiments, substrate engaging surface 101 may be maintained at a temperature of about 18° C. This lower temperature for substrate engaging surface 101 prevents applied ink from becoming too hot so as to enable the ink to set up into a more three dimensional shape and heat to dissipate therefrom.

In some embodiments, ambient air flow may enable sufficient cooling of ink 107, print head 103, and/or substrate engaging portion 101. In some embodiments, one or more cooling elements can be placed near substrate engaging surface 101 or print head 103. In some embodiments, cool air may be circulated over the applied ink as it turns on the drum. In some embodiments, a casing of the printer apparatus that system 100 is a part of can be constructed to allow greater heat escape (e.g., especially the casing near the upper side of substrate engaging portion 101 just past print head 103). In some embodiments, conventional refrigeration, vortex tubing, Peltier elements, or other cooling elements may be used.

In some embodiments, the distance between print head 103 and substrate engaging surface 101 may be such that ink 107 is enabled to set up into a more three-dimensional shape and so that space for accommodating multiple layers of ink 107 is provided. For example, conventional printers may space the print head and transfer drum between about 0.9-1.1 mm from one another. In some embodiments, print head 103 and substrate engaging portion 101 may be spaced at a distance of between about 1.25-2.0 mm. In some embodiments, print head 103 and substrate engaging portion 101 maybe spaced at a distance of between about 1.25-1.5 mm. In some embodiments, for Braille printing, print head 103 and substrate engaging portion 101 maybe spaced at a distance of about 1.6 mm. This increased spacing provides ink 107 with room to set up and provides room for multiple layers of ink. In some instances, this greater spacing enables the cooling techniques discussed above to better cool print head 103, substrate engaging portion 101, and applied ink 107. The greater spacing between print head 103 and substrate engaging portion 101 also makes the hold down technology (e.g., bar 113) less demanding, as the principle failure in most hold down schemes in conventional drum printing is the slapping of the printhead with the substrate trailing edge. This slapping is less prevalent with the greater spacing described herein. Furthermore, the increased spacing prevents “clipping” of the top edge of printed features (layers of ink 111) by a stationary print head 103 as substrate 105 rotates on substrate engaging portion 101.

System 100 may be used for raised digital printing using curable phase change inks in a multi-pass process, wherein print head 103 applies a plurality of layers (e.g., 110 layers of ink, fewer or more or more layers may be used) of ink 107 onto substrate 105 (see e.g., applied layers 111 of ink in FIG. 1A). This process may be used to build-up layers of ink 107 on the substrate so as to digitally print Braille (i.e., various raised dots representing text/numbers) or other raised text or printing. For example, in applications for Braille printing, the applied layers 111 may form a generally circular object having a height of at least 0.5 mm and/or a diameter of approximately 1.44 mm. Accordingly, system 100 may enable printing of Braille that conforms with one or more requirements for Braille printing for use by disabled persons. In some embodiments, the applied layers may form an object having a height of between about 0.3 mm and 0.7 mm. In some embodiments, the applied layers may form an object having a height of between about 0.4 mm and 0.6 mm. In some embodiments, the applied layers may form an object having a diameter of between about 1.25 mm and 1.75 mm. In some embodiments, the applied layers may form an object having a diameter of between about 1.4 mm and 1.5 mm. In some embodiments, a pause or break of a predetermined length of time may be included between application of layers of ink 107 onto substrate 105 so as to allow individual layers of ink 107 to set between applications. For example, in some embodiments, a pause of 30 second between application of layers of ink 107 may be used. The duration of the pause may depend on the ink formulation used and the degree of cooling of the printed ink on the substrate engaging portion. In some embodiments, the pause may be shorter than 30 seconds, for example, as short as 5 seconds.

In some embodiments, when a print drum is used as substrate engaging portion 101, at least part of the pause or break may occur while print drum rotates (see e.g., arrows in FIGS. 1A and 1B). This rotation may bring the portion of substrate 105 where ink 107 was applied out of position (i.e., for printing) relative to print head 103. The rotation then may bring the portion of substrate 105 where ink 107 was applied back into position (i.e., for printing) relative to print head 103. Accordingly, a complete rotation of the print drum may occur between application of each layer of ink. Once the specified plurality of layers 111 are applied, plurality of layers 111 may be cured into a solid phase using curing portion 109.

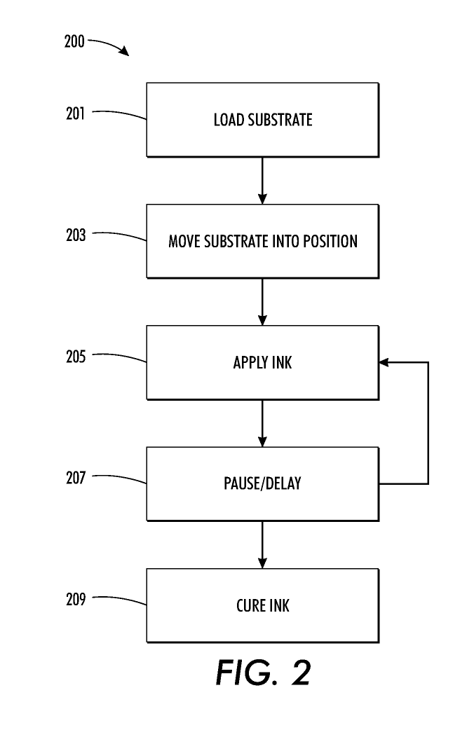

FIG. 2 illustrates a process 200, which is an example of a method for digital printing of Braille and/or other raised printing. Process 200 may include an operation 201, wherein a substrate (e.g., substrate 105) is loaded onto a substrate engaging surface (e.g., substrate engaging surface 101). As described herein, in some embodiments, the substrate may include paper, cloth, plastic, polymer (e.g., uncoated Mylar™), or other substrate that is receptive to a curable, phase change ink and that can be affixed to a substrate engaging portion. In some embodiments, the substrate engaging portion may be a print drum used with conventional inkjet printers. In some embodiments, the substrate may be secured to the substrate engaging portion using one or more hold down or gripper bars (e.g., bars 113), electrostatic forces, suction, tape, adhesive, and/or other elements.

In an operation 203, the substrate may be moved into position with respect to a print head (e.g., print head 103) so as to receive ink (e.g., ink 107) from the print head. As described herein, in some embodiments, the substrate engaging portion may be a print drum. In these embodiments, moving the substrate into position (i.e., moving a portion of the substrate on which printing is to occur into position) may include rotation of the print drum into a position with respect to the print head such that the substrate (i.e., the portion of the substrate on which printing is to occur) is in position for printing. As described herein, in some embodiments, a space of between about 1.25-2.0 mm may be provided between the substrate engaging portion and the print head. In some embodiments, a spacing of between about 1.25-1.5 mm may be provided between the substrate engaging portion and the print head. In some embodiments, for Braille printing, a spacing of about 1.6 mm may be provided between the substrate engaging portion and the print head. As discussed herein this spacing may, inter alia, allow room for application of a plurality of layers of the ink onto the substrate and allow circulation of air to aid in setting into a given shape and height.

In an operation 205, the print head may then apply a layer of the curable phase-change ink onto the substrate. As described herein, the ink may be a UV curable, gel-based, phase-change ink that enables raised printing. In some embodiments, the substrate engaging surface (e.g., transfer drum/print drum) which holds the substrate may be kept at a temperature of between about 10-20° so as to further enable raised printing. In some embodiments, the substrate engaging surface may be maintained at a temperature of about 18° C. Furthermore, the print head may be maintained at a jetting temperature of between about 55-65° (e.g., so that the ink exits the print head at a range of about 55-65° C.). In some embodiments, the print head may be kept at a jetting temperature of about 60° C. (e.g., so that the ink exits the print head at 60° C.). Other temperatures may be used. For example, depending on the ink used temperatures between 55-95° C. may be used.

In an operation 207, a pause or delay may occur so as to allow the ink to at least partially set. In some embodiments, the pause or delay may last for 30 seconds. In some embodiments, lesser or greater periods of time may be used. The pause of operation 207 enables heat to dissipate from the ink applied onto the substrate so that successive applications of ink do not deform previously applied ink layers. In this manner, a plurality of sequentially applied ink layers may be built up, providing raised characteristics (e.g., Braille, raised letters) onto the substrate.

As described herein, part or all of the pause or delay may occur while the portion of the substrate on which application of ink occurred is rotating on a print drum away from, and subsequently back towards, the print head.

In some embodiments, process 200 may return to operation 205, wherein an additional layer of ink is applied onto the substrate. This application may be followed again by another pause operation 207. In some embodiments, process 200 may cycle through operations 205 and 207 so that a plurality of layers of the ink are sequentially applied onto the same portion of the substrate until a specified height of the ink layers (e.g., ink layers 111) is reached. For example, in some embodiments, 110 layers of ink may be sequentially applied onto the same spot so as to provide a raised area. In some embodiments, for example when used for Braille printing, the plurality of layers of applied ink may form a generally circular object having a height of about 0.5 mm and/or a diameter of about 1.44 mm. This height exceeds the minimum height required for Braille dots by the National Library For The Blind And Physically Handicapped Materials Development Center. Other heights, and diameters may be achieved and a plurality of these generally circular objects may be made. Accordingly, the systems and methods provided herein enable robust digital printing of Braille in any number of applications according to any number of Braille standards. Layers of ink may be applied to form other shapes having these or other heights or other dimensions. For example, in some embodiments, the applied layers may form an object having a height of between about 0.3 mm and 0.7 mm. In some embodiments, the applied layers may form an object having a height of between about 0.4 mm and 0.6 mm. In some embodiments, the applied layers may form an object having a diameter of between about 1.25 mm and 1.75 mm. In some embodiments, the applied layers may form an object having a diameter of between about 1.4 mm and 1.5 mm. Accordingly digital raised printing of any kind may be achieved using the systems and methods provided herein.

In an operation 209, the layered ink may then be cured. For example, the layered ink may be cured using a UV light source (e.g., curing portion 109). In some embodiments, the light source may be a light emitting diode (LED) or other light source that emits UV light onto applied layers of ink. In some embodiments, the UV light may have a wavelength of 395 nm. Other curing methods may be used.

In some embodiments, existing printing apparatus may be adapted and used to provide the systems and methods described herein. For example, the architecture of a Phaser 8860™ printer (manufactured by Xerox, Corporation) may be modified to provide the systems and methods described herein.

As described herein, the systems and methods provided may be used for digital printing of Braille. Braille printing using the systems and methods provided herein were compared using optical profilometry with Braille features generated using embossing machinery. Table 1 shows a comparison of standards for Braille printing to the results obtained using the systems and methods disclosed herein.

TABLE 1

| | Required Standard (mm) | Measured (mm) |
|---|---|---|
| Height | 0.48 | ~0.5 |
| Diameter | 1.44 | ~1.4 |

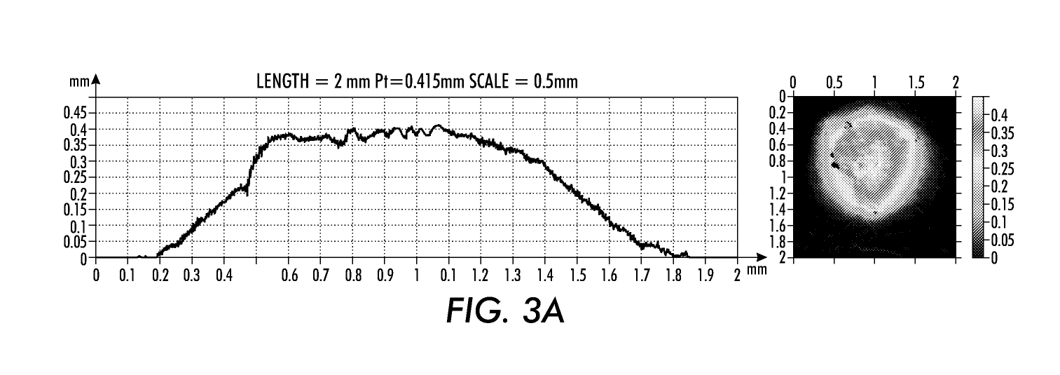

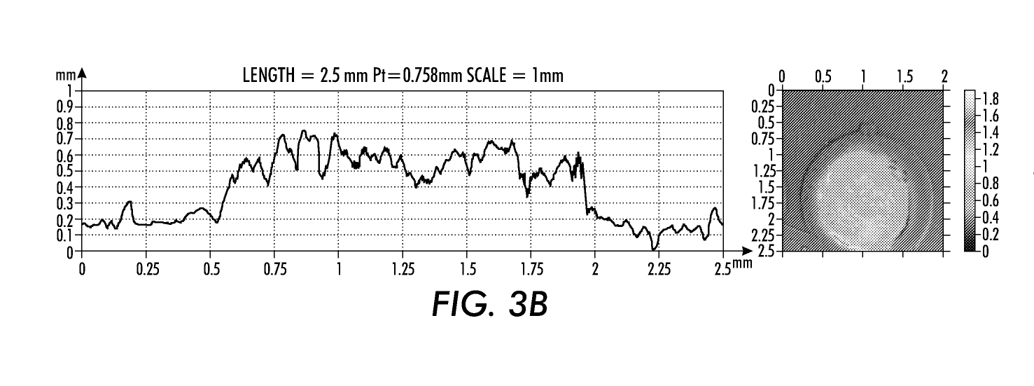

FIG. 3A illustrates optical profilometry results for the embossed Braille dot, while FIG. 3B illustrates optical profilometry results for the digitally printed Braille dot formed using the systems and methods provided herein. As Table 1 and FIGS. 3A and 3B illustrate, the systems and methods provided herein provide Braille characters of sufficient diameter and height. The jagged nature of the profilometer output of FIG. 3B does not represent the smooth appearance of the dot; the reflective nature of the polymer dot produces a noisier signal than the light scattering behavior of the embossed dot.

In some embodiments, computer-implemented components enabling control of the systems and processes described herein may be provided. For example, one or more processing units (e.g., microprocessors) may execute instructions stored in associated memory (non-volatile memory such as, for example, eeprom) to control the components herein and perform the features and functions described herein.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

While the description above refers to particular embodiments, it will be understood that many modifications may be made without departing from the spirit thereof. The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

All the patents and applications referred to herein are hereby specifically, and totally incorporated herein by reference in their entirety in the instant specification.

What is claimed is:

1. A method for digital raised printing comprising:
placing a substrate onto a substrate engaging surface;
sequentially applying a plurality of layers of a curable phase-change ink from a print head onto the substrate, wherein a predetermined period of time elapses between the application of each layer; and
curing the plurality of layers of ink on the substrate.

2. The method of claim 1, wherein the curable phase-change ink is an ultraviolet-curable, gel-based, phase-change ink, and wherein curing the plurality of layers includes curing the plurality of layers using ultraviolet light.

3. The method of claim 1, wherein the plurality of layers are between 0.4 mm and 0.6 mm high from a surface of the substrate.

4. The method of claim 1, wherein the plurality of layers form a generally circular object having a diameter of between 1.4 mm and 1.5 mm.

5. The method of claim 1, wherein the substrate engaging surface is maintained at a temperature of between 10° C. and 20° C.

6. The method of claim 1, wherein a jetting temperature of the print head is between 55° C. and 65° C.

7. The method of claim 1, wherein a spacing between the print head and the substrate engaging surface is between 1.25 mm and 2.0 mm.

8. The method of claim 1, wherein the substrate engaging surface is a print drum.

9. The method of claim 1, wherein the substrate is held to the substrate engaging surface by one or more of a bar, electrostatic forces, or suction.

10. A system for digital raised printing comprising:
a substrate engaging surface that receives and holds a substrate on which ink is to be applied;
a print head that sequentially applies a plurality of layers of a curable phase-change ink onto the substrate, wherein a predetermined period of time elapses between the application of each layer; and
a curing portion that cures the plurality of layers of ink on the substrate.

11. The system of claim 10, wherein the curable phase-change ink is an ultraviolet-curable, gel-based, phase-change ink, wherein the curing portion includes a source of ultraviolet light, and wherein the plurality of layers are cured through exposure to ultraviolet light from the source of ultraviolet light.

12. The system of claim 10, wherein the plurality of layers are between 0.4 mm and 0.6 mm high from a surface of the substrate.

13. The system of claim 10, wherein the plurality of layers form a generally circular object having a diameter of between 1.4 mm and 1.5 mm.

14. The system of claim 10, wherein the substrate engaging surface is maintained at a temperature of between 10° C. and 20° C.

15. The system of claim 10, wherein a jetting temperature of the print head is between 55° C. and 65° C.

16. The system of claim 10, wherein a spacing between the print head and the substrate engaging surface is between 1.25 mm and 2.0 mm.

17. The system of claim 10, wherein the substrate engaging surface is a print drum.

18. The system of claim 10, wherein the substrate is held to the substrate engaging surface by one or more of a bar, electrostatic forces, or suction.

19. A system for digital raised printing comprising:
a print drum that receives and a substrate on which ink is to be applied;
a substrate holding portion that holds the substrate to the print drum;
a print head that sequentially applies a plurality of layers of a gel-based curable phase-change ink onto the substrate, wherein a jetting temperature of the print head is between 55° C. and 65° C. during application of each of the plurality of layers, wherein the print drum is maintained at a temperature of between 10° C. and 20° C. during application of each of the plurality of layers, and wherein a predetermined period of time elapses between the application of each layer; and
a curing portion that emits ultraviolet light onto the substrate to cure the plurality of layers of ink on the substrate.
